(19) United States
(12) Patent Application Publication
(10) Pub. No.: US 2019/0305940 A1
(43) Pub. Date: Oct. 3, 2019

(54) GROUP SHAREABLE CREDENTIALS

(71) Applicant: CA, Inc., New York, NY (US)

(72) Inventors: Gyaneshwar BHABBUR, Secunderabad (IN); Nirupama BEHERA, Sambalpur (IN)

(73) Assignee: CA, Inc.

(21) Appl. No.: 15/937,977

(22) Filed: Mar. 28, 2018

(51) Int. Cl. H04L 9/08; H04L 29/06; H04L 9/32

(52) U.S. Cl. CPC H04L 9/0833; H04L 9/0643; H04L 9/3226; H04L 63/065

(57) ABSTRACT

A method is described for receiving a group credential request for a group from a second user, the group credential request comprising a first challenge and a second challenge, where the first challenge is a hashed string of characters and the second challenge is a version of the first challenge encrypted with a private key. The method includes using a public key associated with a first user to determine whether the private key is associated with the first user. The method further includes, in response to determining that the private key is associated with the first user, transmitting group credentials to the second user, the group credentials comprising a group shared key.

### BACKGROUND

The present invention relates generally to authentication, and more specifically to group shareable credentials.

### SUMMARY

A method is described for receiving a group credential request for a group from a second user, the group credential request comprising a first challenge and a second challenge, where the first challenge is a hashed string of characters and the second challenge is a version of the first challenge encrypted with a private key. The method includes using a public key associated with a first user to determine whether the private key is associated with the first user. The method further includes, in response to determining that the private key is associated with the first user, transmitting group credentials to the second user, the group credentials comprising a group shared key.

### BRIEF DESCRIPTION OF THE DRAWINGS

Aspects of the present disclosure are illustrated by way of example and are not limited by the accompanying drawings.

FIG. 1A illustrates an encryption system in a non-limiting embodiment of the present disclosure.

FIG. 1B illustrates systems in an encryption system in a non-limiting embodiment of the present disclosure.

FIG. 2 illustrates an encryption system and information flow that may be performed by a credential system in a non-limiting embodiment of the present disclosure.

FIG. 3 is a flowchart of operations and information flows that may be performed by a credential system of a non-limiting embodiment of the present disclosure.

FIG. 4 is a flowchart of operations and information flows of a group creation process that may be performed by a credential system of a non-limiting embodiment of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD- ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The present disclosure describes an encryption system that allows end users to dynamically create and manage groups without the need for server-side group management by system administrators. More particularly, the present disclosure describes an encryption system that uses a user private key and group shared key to allow for direct peer-to-peer communication in a secure fashion without system administrator involvement.

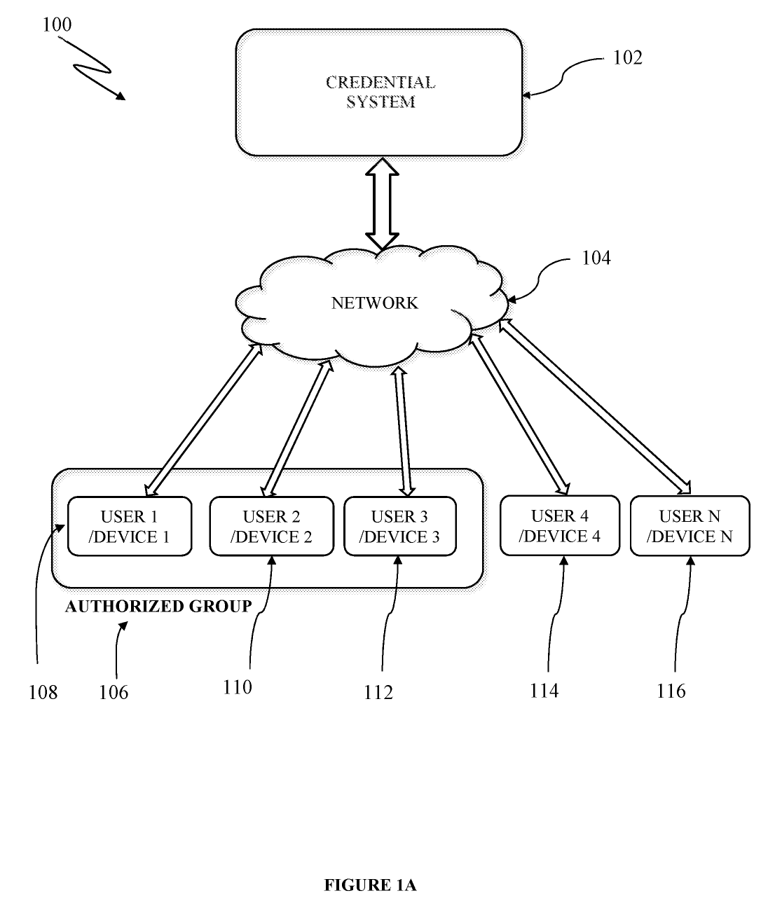

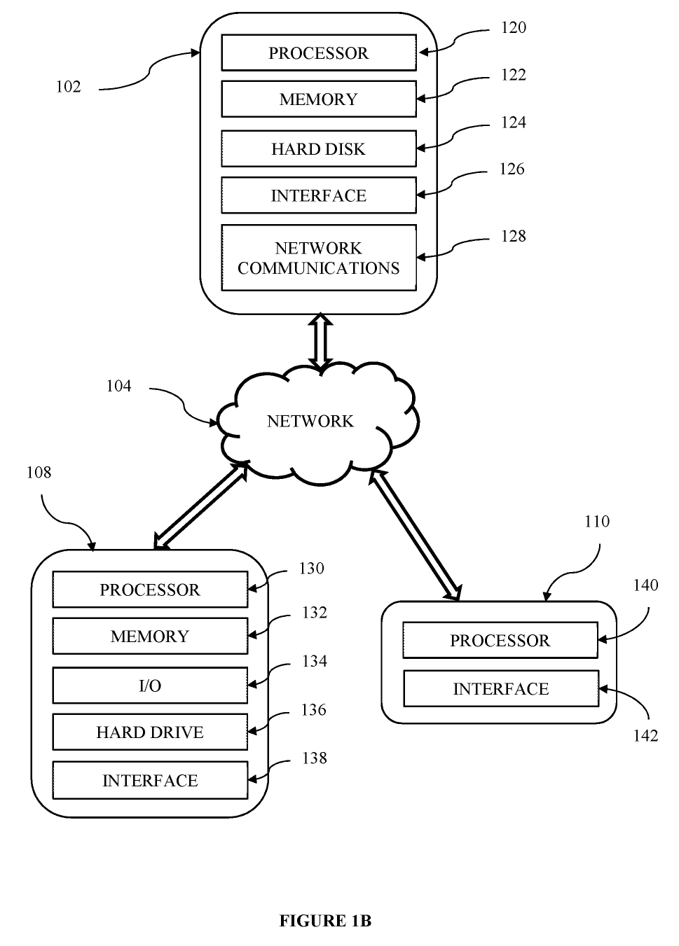

FIG. 1A illustrates an encryption system 100 in a non-limiting embodiment of the present disclosure. An encryption system 100 may include a credential system 102, network 104, an authorized group 106, users/devices associated with the group 108-112, and users not associated with the group 114-116.

The credential system 102 may be located on the cloud, on an external network, or on an internal network. In some non-limiting embodiments, the credential system 102 may be partially located on a local device and partially on the cloud or a network, or any combination thereof. Furthermore, some non-limiting configurations of the credential system 102 may be located exclusively on a user's device 108. The credential system 102 may be accessed by the users/devices 108-116 either directly, or through a series of systems configured to facilitate credential requests to be passed to and from the credential system 102. In some embodiments, the credential system 102 may be already configured to handle user login and secured communication protocols between the user/device and the credential system. In some embodiments, the secure communication protocol implemented by the credential system 102 may be a public key infrastructure (“PKI”) system, where the PKI maintains roles, policies, and procedures needed to create, manage, distribute, use, store, and revoke digital certificates and manage public key encryption.

Network 104 may comprise one or more entities, which may be public, private, or community based. Network 104 may permit the exchange of information and services among users/entities that are connected to such network 104. In certain configurations, network 104 may be a local area network, such as an intranet. Further, network 104 may be a closed and/or private network/cloud in certain configurations, and an open network/cloud in other configurations. Network 104 may facilitate wired or wireless communications of information and provisioning of services among users that are connected to network 104.

The authorized group 106 may comprise one or more users/devices 108-116. The authorized group is provisioned by the credential system 102 in response to a request from a user to create a group. The authorized group 106 may be one of a plurality of authorized groups provisioned by the credential system 102. A single user/device 108 may belong none, one, or many authorized groups 106. In certain embodiments, the users/devices 108-116 allowed to access an authorized group 106 may be statically allocated or dynamically managed. In certain embodiments, the authorized group 108-116 may have a defined expiry time, may be permanent, or may have the group provision revoked on-demand.

The users/devices 108-116 may comprise many different types of users and/or devices. Some user examples include local users, remote users, users authorized to use secured communication with the credential system, and users within an authorized group 108-112. Some device examples include computers, laptops, printers, network routers, network storage, cloud devices, mobile devices, wearable computing devices, and smart home devices. The users/devices 108-116 may be connected to the network 104, at least at the time of communications to network connected users/devices 108-116 described herein.

FIG. 1B illustrates systems in an encryption system 100 in a non-limiting embodiment of the present disclosure. The systems in an encryption system 100 may include a credential system 102, a network 104, and users/devices 108-116. The credential system 102 may include a processor 120, volatile memory 122, a hard disk or non-volatile memory 124, an interface 126, and/or network communications 128. The devices 108-116 may include a processor 130, volatile memory 132, input/output devices 134, a hard disk or non-volatile memory 136, and/or an interface 138. In some embodiments, the devices 108-116 may include just a processor 140 and an interface 142.

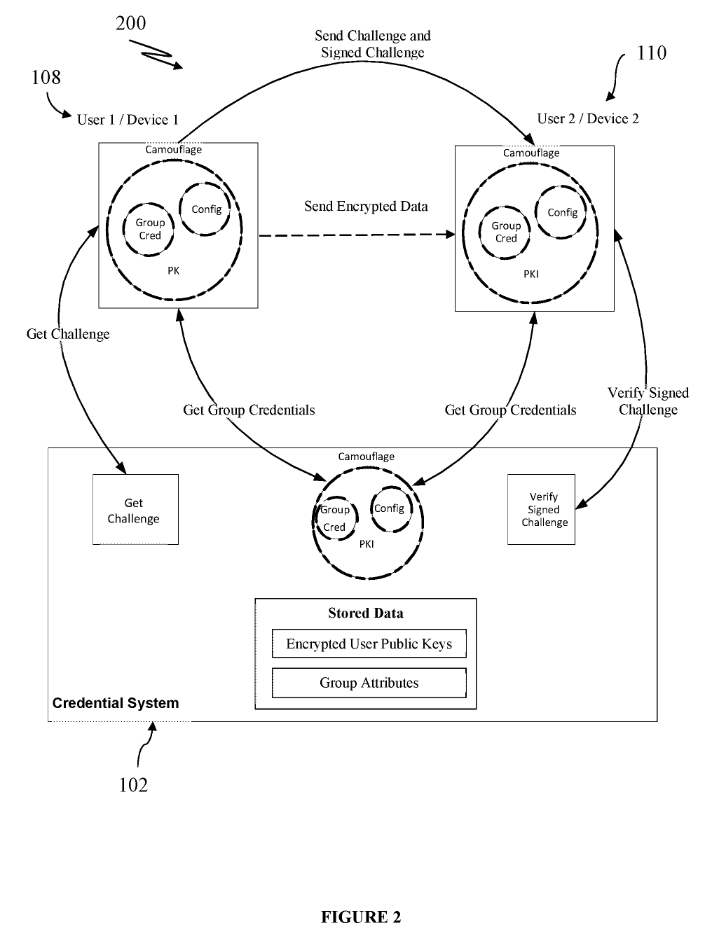

FIG. 2 illustrates an encryption system 100 and information flow 200 that may be performed by a credential system 102 in a non-limiting embodiment of the present disclosure. The information flow 200 illustrated in FIG. 2 is organized to facilitate the secure, direct communication between two users/devices 108 and 110 without intervention or management by system administrators.

The credential system 102, in the embodiment depicted in FIG. 2, facilitates the direct communication between users/devices 108 and 110. The direct communication between the users/device 108 and 110 may consist of the first user 108 creating a group on the credential system 102, and receiving a challenge and group credentials from the credential system 102. The group credentials may include at least a group shared key. The first user 108 may then sign the challenge using the first user's private key and encrypt a message (e.g., information, data, files, images, streams, bytecode) using the group shared key. The first user 108 may then send the challenge, the signed challenge, and the encrypted message to the second user 110. The second user 110 may then obtain the group credentials from the credential server 102 to obtain the group shared key. The second user 110 may then use the group shared key to decrypt the message from the first user 108. In some embodiments, the second user 110 may also receive additional messages from the first user 108 without having to retrieve the group shared key from the credential server 102 for each message. FIG. 2 also depicts the credential server 102 storing encrypted user public keys and group attributes, where each user public key is associated with a user private key, and where the user public keys may be encrypted using a credential server secret key known only to the credential server 102.

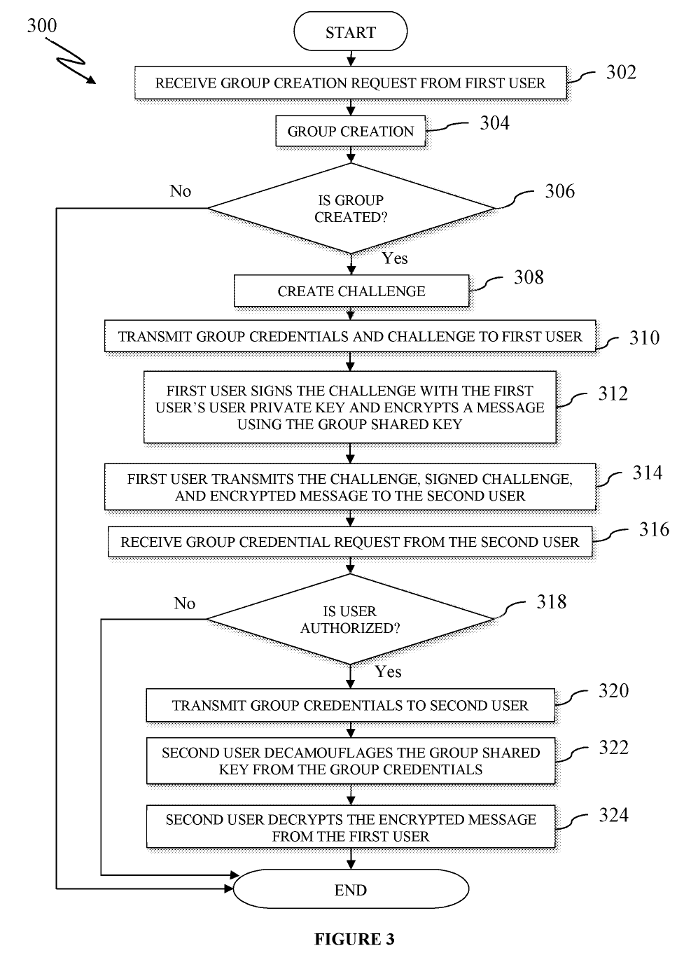

FIG. 3 depicts a flowchart of operations 300 and information flows that may be performed by a credential system 102 of a non-limiting embodiment of the present disclosure. This flowchart 300 describes how a user 108, in a particular embodiment, may create a group, transmit an encrypted message to a second user/device 110, and how that second user/device 110 may decrypt that encrypted message.

The flowchart of operations 300 begins in step 302 with a group creation request from the first user 108. The group creation request may include several pieces of information to facilitate the identification and creation of a group by the credential system 102. In some embodiments, the group creation request identifies the other users of the group, the group expiry time, and other group associated attributes or flags. The other users of the group may be identified based on a user/device ID, a user/device name, or any other identification system in place within the encryption system 100.

The group expiry time may be included in the group creation request to indicate the length of time that the group is valid, and the users/devices of the group can directly send messages to each other. The group expiry time may be short-lived (e.g., minutes, hours, or days) or long-lived (e.g., weeks, months, or years) depending on the requirements of the user/device. The group expiry time may be enforced by a public key infrastructure system, where a group shared key is inaccessible after the group expiry time has tolled, or where the group shared key is unable to encrypt/decrypt a message after the group expiry time. In some embodiments, a determination that the group expiry time has tolled may be made by the credential system 102 when distributing the group shared key.

The group associated attributes or flags may also be included in the group creation request to provide additional information to the encryption system 100 to define the interactions of the group. For example, in a non-limiting embodiment, the group associated attributes may include information used to decamouflage the group shared key (e.g., user PIN, group PIN, or group password), information used to decamouflage the user private key (e.g., user PIN or user password), group issued date, group ID, whether a peer must validate a challenge, and whether a peer must validate a new challenge.

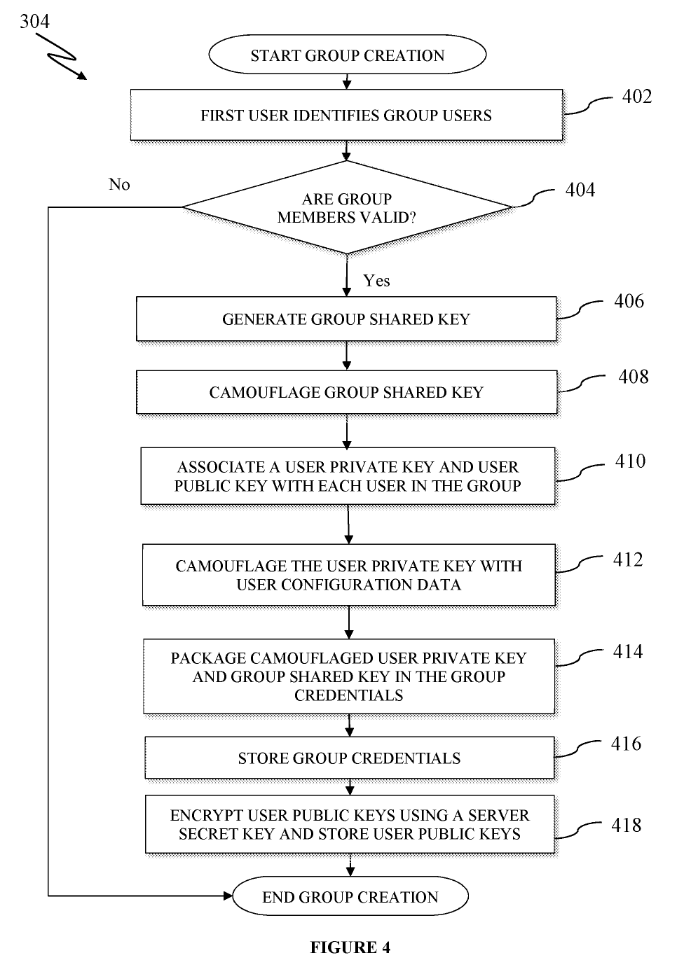

Upon receiving the group creation request, the credential system 102 will begin the group creation process in step 304. This step is described in FIG. 4, which is a flowchart of operations and information flows of a group creation process 304 that may be performed by a credential system 102 of a non-limiting embodiment of the present disclosure. The group creation process 304 requires that the group creation request sent by the first user/device 108, at a minimum, identify the group users, as depicted in step 402. In step 404, the credential system 102 may validate the group users by checking if each of the group users is a member of the encryption system 100.

In step 406, if the group members are valid, the credential system 102 may generate a group shared key. The group shared key is a key that may be used by the users of the group to encrypt and decrypt a message sent between users of the group. In some embodiments, group shared key may simply be a string of characters generated by the credential system 102. In another embodiment, the group shared key may be derived from various information such as the group expiry time, users of the group, or group associated attributes. In yet another embodiment, the group shared key may consist of two keys, one group encryption key and a second group decryption key. In the embodiments where a single group shared key is created, the group shared key may be distributed to each of the members of the group in order to encrypt and decrypt messages directly sent between members of the group.

After the group shared key is generated by the credential system 102, the group shared key may be camouflaged in step 408. Cryptographic camouflage is the process of encrypting information using a key, where an attempted decryption using an incorrect key would result in information that appears valid to the end user. For example encrypting a phone number using a user PIN will generate an encrypted string of characters. Decrypting that encrypted string with an invalid PIN may give any combination of numbers and letters in a decrypted string. An entity trying to crack the encryption may attempt many such invalid PINs, knowing that the encrypted information takes the particular format of a phone number, until the result of the decryption matches the format expected. However, when using a cryptographic camouflage to encrypt the phone number, the use of any decryption key that resembles a PIN (e.g., any four digit number) would result in decrypted information that matches the format of a phone number. The use of an incorrect PIN would result in decrypted information that is a phone number, albeit an incorrect phone number. In some embodiments, the cryptographic camouflage may make it more difficult for nefarious entities to reliably decrypt information.

In step 408, the cryptographic camouflage applied to the group shared key may be based on some information available to the user, such as a user PIN or a user password. In other embodiments, the cryptographic camouflage applied to the group shared key may be based on information only in the possession of the credential system 102, such as a group PIN. In this embodiment, the group PIN would be accessed by a user/device by authenticating with the credential system 102 and receiving the group PIN in response to that authentication. Alternatively, if the cryptographic camouflage is applied based on information available to the user, the specific piece of information (e.g., the user PIN or user password) may be identified by the credential system 102 after authenticating that user. In other embodiments, the group shared key may not be individually camouflaged, but rather camouflaged along with other information packaged in a group credential.

In step 410, the credential system 102 may associate a user private key and a user public key with each user in the group. The user private key may be used to encrypt information, while the user public key may be used to decrypt information encrypted using the user private key. In some embodiments of the present invention, the user private key is already known to the user/device at the time of the group creation. In other embodiments, the user private key is a new key generated by the credentials system 102 and provided to the user/device. In some embodiments, the user private key is already available to the credential system 102 and is simply provided to the user/device. In the embodiment depicted in FIG. 2, the user private key may be used by a first user/device 108 to encrypt a challenge sent to the second user/device 110. The user public key is also associated with the user/device, but is not distributed to any users/devices within the encryption system 100. The user private key may be primarily used to encrypt messages sent back and forth from the credential system 102, and encrypt information sent to the peer for identification purposes by the credential system 102.

In step 412, the credential system 102 may camouflage the user private key with user configuration data (e.g., user PIN or user password). In some embodiments, the user private key may be camouflaged with information available only to the user/device, such as the user's PIN or password. In other embodiments, the user private key may not be camouflaged individually, but camouflaged after being packaged within a group credential. One benefit of camouflaging the user private key is that it is more difficult for another entity to intercept and access the user private key.

Once the group shared key and the user private key are available, they may be packaged together into a group credential as in step 414. In some embodiments, the group credentials may contain all the user private keys for the users of the group, with each user private key camouflaged with user specific information. In other embodiments, there may be multiple group credentials for a given group, with one group credential for each user of the group which includes the user private key for only a single user. One benefit of including a single user private key per group credential is that a given user private key is distributed to only a single user rather than to each user within the group, reducing the possibility of a user private key being compromised.

After creating the group credentials for a given group, the credential system 102 stores the group credentials in step 416. In some embodiments, the group credentials may themselves be encrypted by the credential system 102 before being stored, using an encryption method only decryptable by the credential system 102. The group credential storage may exist locally on the credential system, or in a secure location in the encryption system 100, such as in an encrypted database. In some embodiments, the group credentials may also be camouflaged before being stored locally, so that a group credential may only be decamouflaged by the user for whom the group credential is created.

In step 418, the credential system 102 may encrypt the user public keys, associated with each user in the group, using a system secret key, and store the encrypted user public keys. The system secret key may be an encryption key known only to the credential system 102, thereby only allowing the credential system 102 to access the user public keys. In some embodiments of the present disclosure, the primary use of the user public keys is to provide secure communication between the user/device 108-116 and the credential system 102, and to verify the identity of the sender and/or recipient of a peer message. Upon encryption and storage of the user public keys in step 418, the group creation process 304 is completed. In embodiments where the group creation process 304 is dynamic (i.e., group users may be added or removed from the group after group creation), the group creation process 304, or steps within the group creation process 304, may be subsequently executed again.

Upon completion of the group creation process 304, the flowchart of operations 300 continues to step 306, to verify if a group was validly created. Verifying the creation of a group may consist of verifying that the group credentials were created for the group and verifying that the user public keys for that group are available to the credential system 102. If the group was not created, the flow of operations 300 may end, and a response may be sent to the first user/device 108 indicating a failure to create the group.

If a group is created in step 304, then the system may create a challenge in step 308. In some embodiments of the present disclosure, the challenge is a random string of characters generated by the credential system and associated with the group created in step 304. In another embodiment, the challenge may be a string of characters generated based on a variety of information such as the group expiry time, users of the group, or group associated attributes. The challenge itself may be encrypted by the credential system using a system secret key so that the information encoded within the challenge string is unreadable by other users/devices. The challenge may be created to identify a group, and may be sent to members of the group to verify the sender and recipient of a message within the group. In some embodiments, the challenge may be specific to each user within a group, such that the challenge uniquely identifies the both the user and the group. In this embodiment, the credential system may be able to more accurately identify the sender and recipient of a message within the group. In another embodiment, the challenge may be a question whose answer is known by the credential system. In this embodiment, the challenge is answered by each user/device when the challenge is used, preferably with information only available to the user/device and the credential system. An example of a challenge in such an embodiment is “what is the user/device ID” or “what is the user/device PIN.”

Upon creation of the group in step 304 and creation of the challenge in step 308, credential system may transmit the group credentials and the challenge to the first user 108. In some embodiments, the group credentials and the challenge may be transmitted separately to the first user. For example, in some embodiments, only the challenge may be transmitted to the first user 108. Upon receiving the challenge, the first user 108 signs the challenge using the user private key and sends the challenge and signed challenge to the credential system 102. Only upon verifying the challenge signed by the first user 108, the credential system 102 may sends group credentials to the first user 108.

In step 312, once the first user/device 108 has obtained the group credentials and the challenge, the first user/device 108 may sign the challenge with the first user/device's user private key and encrypt a message with the group shared key. Depending on the embodiment of the present disclosure, in order to sign the challenge, the first user/device may need to decamouflage the group credentials and/or the user private key. If camouflaged, the user private key may be decamouflaged using information available to the first user/device, such as the user/device' PIN or user/device's password. Similarly, the group shared key may be camouflaged, and may need to be decamouflaged using information either available to the user/device, or using information provided from the credential system 102. In embodiments where the challenge is a question, the first user 108 may need to answer the question, then sign the answer using the first user/device's user private key. The message encrypted using the group shared key is any message intended to be sent to the second user/device 110 within the authorized group 106.

In step 314 the first user/device 108 may transmit the challenge, signed challenge, and encrypted message to a second user/device 110 within the authorized group 106. In some embodiments, the transmission of the challenge, signed challenge, and encrypted message may be transmitted to the credential system 102, or another authorized intermediary entity within the encryption system 100, which facilitates the transmission of information between user/devices 108-112 belonging to the authorized group 106. In this embodiment, rather than directly sending the message to a second user/device 110, the first user/device 108 sends the information to an authorized intermediary, who makes the information available to the second user/device 110 upon authentication of the second user/device 110 and group 106 in step 318.

Upon receiving the information in step 314 from the first user/device 108, the second user/device 110 may send a group credential request in step 316. The group credential request may include the first user/device's challenge and the challenge signed by the first user/device's user private key. In embodiments where the second user/device already has their user private key, the group credential request may also include the challenge from the first user/device signed with the second user/device's user private key. The group credential request may also include other information passed between the first user/device 108 and the second user/device 110 such as the sender's ID, the recipient ID, the group ID, or other identifying information.

Upon receiving the group credentials request from the second user/device 110, the credential system 102 verifies if the second user/device 110 is authorized to access the group 106. The credential system 102 may use the challenge to identify the authorized group 106 for which the second user/device 110 is requesting credentials. In the embodiments where the challenge is encrypted by the credential system 102, the credential system may need to decrypt the challenge before validating the associated group 106. The credential system 102 may further validate that the signed challenge was indeed signed by the first user's user private key by using the user public key associated with the first user 108 to decrypt the signed challenge and compare the result to the challenge. Further, if the credential system 102 receives a challenge signed by the second user's user private key, the credential system 102 may similarly use the user public key associated with the second user/device 110 to decrypt the second signed challenge and compare the result to the challenge. The credential system 102 may also check during step 318 whether the group 106 has expired or is still valid. Finally, the credential system 102 will also verify that the second user/device 110 is a member of the group 106.

In step 320, if the second user/device 110 is authorized to access the group 106, the credential system may transmit the group credentials to the second user/device 110. Upon receiving the group credentials, in step 322, the second user/device 110 may decamouflage the group shared key and/or the user private key contained in the group credentials. The information necessary to decamouflage the group shared key may be transmitted to the second user/device as part of the group credentials.

In some embodiments, the second user/device may need to send a second authorization request, or a group camouflage request, to the credential system 102 after receiving the group credentials in step 320. In addition to transmitting the group credentials to the second user/device 110 in step 320, the credential system 102 may send a second challenge to the second user/device 110. After receiving the group credentials in step 320, the second user/device 110 may decamouflage the user private key included in the group credentials. The group camouflage request may consist of the first challenge, the first challenge signed by the first user/device's user private key, the first challenge signed by the second user/device's user private key, the second challenge, and the second challenge signed by the second user/device's user private key. Upon validating each of these challenges, the credential system 102 would transmit information needed to decamouflage the group shared key included in the group credentials transmitted to the second user/device 110.

In step 322, the second user/device 110 may decamouflage the group shared key included within the group credentials. Upon obtaining the group shared key, the second user/device 110 may be able to decrypt the message sent by the first user/device 108 to the second user/device 110 using the group shared key.

Subsequent messages sent between the first user/device 108 and the second user/device 110 may not require additional interaction with the credential system 102. The first user/device 108 may simply send additional messages, encrypted using the group shared key, to the second user/device 110, and the second user/device may use the group shared key to decrypt those additional messages. In other embodiments, subsequent messages sent between the first user/device 108 and the second user/device 110 may require validation by the second user/device 110 with the credential system 102 for each subsequent message.

In embodiments that have a group expiry time, the PKI credential may be used to expire the group credentials or the group shared key. In other embodiments, the group shared key may be configured in such a way as to prevent the encryption or decryption of information using the group shared key after the expiry time. One such method for configuring the group shared key to incorporate such an expiry time may be to include a modified timestamp (e.g., a timestamp rounded to the nearest minute, five minutes, ten minutes, or hour) as part of the group shared key encryption wherein the group shared key cannot be reliably used for both encryption and decryption if the timestamp is after the group expiry time.

An example non-limiting embodiment of the encryption system 100 described in the present disclosure is as follows. A first user 108, a second user 110, and a third user 112 may log into an encryption system 100 for the first time using their username and password. The credential system 102 may send the users back their PKI credentials. The first user 108 may then sends a group creation request to create a group 106 consisting of the second user 110 and the third user 112. The credential system 102 creates the group and creates group credentials for each user of the group 106 containing a group shared key and the user's private key. The group credentials are camouflaged with each respective user's PIN. The credential system sends the first user's group credentials and a challenge to the first user 108. The first user uses their PIN to decamouflage the group credentials extracting the group shared key and the user's private key. The first user then signs the challenge using the first user's private key and encrypts a message to the second user 110 using the group shared key. The first user 108 then sends the challenge, signed challenge, and encrypted message to the second user 110. The second user 110 receives the challenge, signed challenge, and encrypted message from the first user 108 and sends a group credential request to the credential system 102 with the challenge, the signed challenge from the first user 108, and the user ID for the second user 110. The credential system 102 may validate the challenge and the signed challenge. The credential system 102 may further validate that the second user is authorized to access the group 106. The credential system 102 may then send the second user 110 the group credentials camouflaged with the second user's PIN. The second user 110 may receive the group credentials and decamouflage the group credentials, using the second user's PIN, to obtain the group shared key. The second user 110 may then decrypts the message received from the first user 108. The first user 108 may then sends a second encrypted message to the second user 110 using the group shared key for encryption. The second user 110 may decrypt the second message received from the first user 108 using the group shared key. The second user 110 may then send an encrypted message, the challenge, and the challenge signed by the second user's private key to the third user 112. In some embodiments, following the same process described above, the third user 112 obtains the group credentials from the credential system and decrypts the message sent from the second user 110 to the third users 112 using the group shared key.

The flowchart and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving a group credential request for a group from a second user, the group credential request comprising a first challenge and a second challenge;
wherein the first challenge comprises a hashed string of characters and the second challenge comprises a version of the first challenge encrypted with a private key;
using a public key associated with a first user to determine whether the private key is associated with the first user; and
in response to determining that the private key is associated with the first user, transmitting group credentials to the second user, the group credentials comprising a group shared key.

2. The method of claim 1, wherein the group shared key is camouflaged with information available to the second user.

3. The method of claim 1, further comprising:
determining whether the first challenge is associated with the group;
wherein using a public key associated with a first user to determine whether the private key is associated with the first user comprises using a public key associated with a first user to determine whether the private key is associated with the first user in response to determining that the first challenge is associated with the group.

4. The method of claim 1, wherein the group credential request includes a first identifier and a second identifier, and further comprising:
determining whether the first identifier is associated with the first user;
determining whether the second identifier is associated with the second user; and
wherein transmitting the group credentials to the second user comprises transmitting the group credentials to the second user in response to determining that the first identifier is associated with the first user and determining that the second identifier is associated with the second user.

5. The method of claim 1, further comprising:
determining whether a group expiry time associated with the group has tolled; and
wherein transmitting group credentials to the second user comprises transmitting the group credentials to the second user in response to determining that the group expiry time associated with the group has not tolled.

6. The method of claim 1, wherein the group shared key is camouflaged, further comprising:
receiving a group camouflage request from the second user, the group camouflage request comprising the first challenge and a third challenge, the third challenge being encrypted with a second private key associated with the second user;
determining whether the first challenge matches a fourth challenge stored locally, the fourth challenge being associated with the group;
in response to determining that the first challenge matches the fourth challenge, decrypting the third challenge using a second public key, the second public key being associated with the second user;
determining whether the first challenge and the decrypted third challenge match;
in response to determining that the first challenge and the decrypted third challenge match, transmitting information to the second user sufficient to decamouflage the group shared key.

7. The method of claim 1, further comprising:
receiving a group creation request from the first user;
provisioning the group with the group credentials;
creating the first challenge; and
transmitting the group credentials and the first challenge to the first user.

8. The method of claim 7, wherein the group creation request comprises group attributes and an identification of group members, the group attributes comprising at least a group expiry time.

9. The method of claim 8, wherein the first challenge comprises a string of characters that is based on the group attributes.

10. The method of claim 8, wherein the group shared key becomes invalid after the group expiry time.

11. A computer configured to access a storage device, the computer comprising:
a processor; and
a non-transitory, computer-readable storage medium storing computer-readable instructions that when executed by the processor cause the computer to perform:
receiving a group credential request for a group from a second user, the group credential request comprising a first challenge and a second challenge;
wherein the first challenge comprises a hashed string of characters and the second challenge comprises a version of the first challenge encrypted with a private key;
using a public key associated with a first user to determine whether the private key is associated with the first user; and
in response to determining that the private key is associated with the first user, transmitting group credentials to the second user, the group credentials comprising a group shared key.

12. The computer of claim 11, wherein the group shared key is camouflaged with information available to the second user.

13. The computer of claim 11, wherein the computer-readable instructions further cause the computer to perform:
determining whether the first challenge is associated with the group;
wherein using a public key associated with a first user to determine whether the private key is associated with the first user comprises using a public key associated with a first user to determine whether the private key is associated with the first user in response to determining that the first challenge is associated with the group.

14. The computer of claim 11, wherein the computer-readable instructions further cause the computer to perform:
wherein the group credential request comprises a first identifier and a second identifier;
determining whether the first identifier is associated with the first user;
determining whether the second identifier is associated with the second user; and
wherein transmitting the group credentials to the second user comprises transmitting the group credentials to the second user in response to determining that the first identifier is associated with the first user and determining that the second identifier is associated with the second user.

15. The computer of claim 11, wherein the computer-readable instructions further cause the computer to perform:
determining whether a group expiry time associated with the group has tolled; and
wherein transmitting group credentials to the second user comprises transmitting the group credentials to the second user in response to determining that the group expiry time associated with the group has not tolled.

16. The method of claim 11, wherein the group shared key is camouflaged, and wherein the computer-readable instructions further cause the computer to perform:
receiving a group camouflage request from the second user, the group camouflage request comprising the first challenge and a third challenge, the third challenge being encrypted with a second private key associated with the second user;
determining whether the first challenge matches a fourth challenge stored locally, the fourth challenge being associated with the group;
in response to determining that the first challenge matches the fourth challenge, decrypting the third challenge using a second public key, the second public key being associated with the second user;
determining whether the first challenge and the decrypted third challenge match;
in response to determining that the first challenge and the decrypted third challenge match, transmitting information to the second user sufficient to decamouflage the group shared key.

17. The computer of claim 11, wherein the computer-readable instructions further cause the computer to perform:
receiving a group creation request from the first user;
provisioning the group with the group credentials;
creating the first challenge; and
transmitting the group credentials and the first challenge to the first user.

18. The method of claim 17, wherein the group creation request comprises group attributes and an identification of group members, the group attributes comprising at least a group expiry time.

19. The method of claim 18, wherein the first challenge comprises a string of characters that is based on the group attributes.

20. A computer program product comprising:
a computer-readable storage medium having computer-readable program code embodied therewith, the computer-readable program code comprising:
computer-readable program code configured to receive a group credential request for a group from a second user, the group credential request comprising a first challenge, a second challenge, a first identifier and a second identifier;
wherein the first challenge comprises a hashed string of characters and the second challenge comprises a version of the first challenge encrypted with a private key;
computer-readable program code configured to determine whether the first identifier is associated with a first user;
computer-readable program code configured to determine whether the second identifier is associated with the second user;
in response to determining that the first identifier is associated with the first user and determining that the second identifier is associated with the second user, computer-readable program code configured to determine whether the first challenge is associated with the group;
in response to determining that the first challenge is associated with the group, computer-readable program code configured to use a public key associated with a first user to determine whether the private key is associated with the first user; and
computer-readable program code configured to determine whether a group expiry time associated with the group has tolled;
in response to determining that the private key is associated with the first user and determining that the group expiry time associated with the group has not tolled, computer-readable program code configured to transmit group credentials to the second user, the group credentials comprising a group shared key;
wherein the group shared key is camouflaged;
computer-readable program code configured to receive a group camouflage request from the second user, the group camouflage request comprising the first challenge and a third challenge, the third challenge being encrypted with a second private key associated with the second user;
computer-readable program code configured to determine whether the first challenge matches a fourth challenge stored locally, the fourth challenge being associated with the group;
in response to determining that the first challenge matches the fourth challenge, computer-readable program code configured to decrypt the third challenge using a second public key, the second public key being associated with the second user;
computer-readable program code configured to determine whether the first challenge and the decrypted third challenge match;
in response to determining that the first challenge and the decrypted third challenge match, computer-readable program code configured to transmit information to decamouflage the group shared key to the second user.
